(19) United States
(12) Patent Application Publication
(10) Pub. No.: US 2025/0356836 A1
(43) Pub. Date: Nov. 20, 2025

(54) JOINT TRAINING

(71) Applicants: Beijing Zitiao Network Technology Co., Ltd., Beijing (CN); Lemon Inc., Grand Cayman (KY)

(72) Inventors: Yuanzhe Chen, Beijing (CN); Jiawei Chen, Beijing (CN); Dongya Jia, Beijing (CN); Chumin Li, Beijing (CN); Jian Cong, Beijing (CN); Zhengxi Liu, Beijing (CN); Zhuo Chen, Los Angeles, CA (US); Yuping Wang, Beijing (CN); Yuxuan Wang, Los Angeles, CA (US)

(21) Appl. No.: 19/207,311

(22) Filed: May 13, 2025

(30) Foreign Application Priority Data
May 14, 2024 (CN) 202410599270.2

(51) Int. Cl. G10L 13/027; G06F 40/284; G10L 13/08

(52) U.S. Cl. CPC G10L 13/027; G06F 40/284; G10L 13/08

(57) ABSTRACT

Embodiments in the disclosure relate to joint training. A method provided herein includes: obtaining a first sequence and a second sequence, wherein the first sequence is generated based on text content and the second sequence is generated based on speech content matching the text content, wherein the first sequence includes a plurality of text tokens and the second sequence includes a plurality of speech tokens; constructing a mixed sequence based on an alignment relationship between the plurality of text tokens and the plurality of speech tokens, the mixed sequence including at least one of the plurality of text tokens and at least one of the plurality of speech tokens; and training a target model with the mixed sequence.

### CROSS-REFERENCE

The present application claims priority to Chinese Patent Application No. 202410599270.2, filed on May 14, 2024, and entitled “METHOD, APPARATUS, DEVICE AND STORAGE MEDIUM FOR JOINT TRAINING”, the entirety of which is incorporated herein by reference.

### FIELD

Example embodiments in the present disclosure generally relate to the field of computers, and in particular, to joint training.

### BACKGROUND

With the development of computer technologies, generative artificial intelligence technology has been applied to various aspects of people's lives. To train a model, it is first necessary to collect a large amount of data. In the field of speech generation (or text generation), during model training, speech-text pair data may be introduced, so that the trained model may generate speech based on text or generate text based on speech and the like.

### SUMMARY

In a first aspect of the present disclosure, a method for joint training is provided. The method includes: obtaining a first sequence and a second sequence, in which the first sequence is generated based on text content and the second sequence is generated based on speech content matching the text content, in which the first sequence includes a plurality of text tokens and the second sequence includes a plurality of speech tokens; constructing a mixed sequence based on an alignment relationship between the plurality of text tokens and the plurality of speech tokens, the mixed sequence including at least one of the plurality of text tokens and at least one of the plurality of speech tokens; and training a target model with the mixed sequence.

In a second aspect of the present disclosure, an apparatus for joint training is provided. The apparatus includes a sequence obtaining module, configured to obtain a first sequence and a second sequence, in which the first sequence is generated based on text content and the second sequence is generated based on speech content matching the text content, in which the first sequence including a plurality of text tokens and the second sequence including a plurality of speech tokens; a mixed sequence generation module, configured to construct a mixed sequence based on an alignment relationship between the text tokens and the speech tokens, the mixed sequence including at least one of the plurality of text tokens and at least one speech token of the plurality of speech tokens; and a model training module, configured to train a target model with the mixed sequence.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium stores a computer program thereon, and the computer program is executable by the processor to implement the method of the first aspect.

It should be understood that the summary described in this disclosure is not intended to limit key features or important features of embodiments in the present disclosure, nor is it intended to limit the scope in the present disclosure. Other features in the present disclosure will become readily understood from the following description.

### BRIEF DESCRIPTION OF DRAWINGS

The above and other features, advantages, and aspects of the various embodiments in the present disclosure will become more apparent from the following detailed description taken in combination with the accompanying drawings. In the drawings, the same or similar reference numbers refer to the same or similar elements, where:

FIG. 1 illustrates a schematic diagram of an example environment in which embodiments according to the present disclosure may be implemented;

FIG. 2 illustrates a flowchart of an example method for joint training according to some embodiments of the present disclosure;

FIG. 3 illustrates a schematic diagram of a first sequence and a second sequence according to some embodiments of the present disclosure;

FIG. 4 illustrates a schematic diagram of constructing a mixed sequence according to some embodiments of the present disclosure;

FIG. 5 illustrates a schematic diagram of constructing a mixed sequence according to some other embodiments of the present disclosure;

FIG. 6 illustrates a schematic structural block diagram of an example apparatus for joint training according to some embodiments of the present disclosure; and

FIG. 7 illustrates a block diagram of an electronic device capable of implementing various embodiments of the present disclosure.

### DETAILED DESCRIPTION

The embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments in the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first”, “second” and the like may refer to different or the same objects. Other explicit and implicit definitions may also be included below.

The embodiments in the present disclosure may relate to user data, acquisition and/or use of data, and the like. These aspects shall comply with the requirements of corresponding laws, regulations and relevant provisions. In the embodiments in the present disclosure, the collection, acquisition, processing, manufacturing, forwarding, use of all data and the like are carried out with user's knowledge and consent. Accordingly, in the implementation of the embodiments in the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As briefly mentioned above, during model training, speech-text pair data may be introduced, which typically consist of speech and corresponding text. The speech may be audio data in various forms such as a recording, a telephone call, and a meeting minute, and the like, and the text is text content corresponding to these audio data. However, the amount of speech-text pair data is limited, so that the effect of model training is difficult to meet expectations.

To this end, the embodiments in the present disclosure provide a method for joint training for model training. The method for joint training includes: an electronic device obtains a first sequence and a second sequence, in which the first sequence is generated based on text content and the second sequence is generated based on speech content matching the text content, in which the first sequence includes a plurality of text tokens and the second sequence includes a plurality of speech tokens. Further, the electronic device constructs a mixed sequence based on an alignment relationship between the plurality of text tokens and the plurality of speech tokens, the mixed sequence including at least one of the plurality of text tokens and at least one of the plurality of speech tokens. Then, the electronic device trains a target model with the mixed sequence.

According to the method of the embodiments in the present disclosure, the text token is generated based on the text content, and the speech token is generated based on the speech content. A mixed sequence including the text token and the speech token is generated based on an alignment relationship between the text token and the speech token, and the mixed sequence is actually a cross modal sequence combining the text content and the speech content. In this way, different mixed sequences may be generated by performing various combinations of the text information in the text content and the speech information in the speech content. Therefore, the embodiments in the present disclosure may extend a large number of sequences to train the target model, thereby improving the training effect of the model.

Various example implementations of this solution will be described in detail below with reference to the accompanying drawings.

### Example Environment

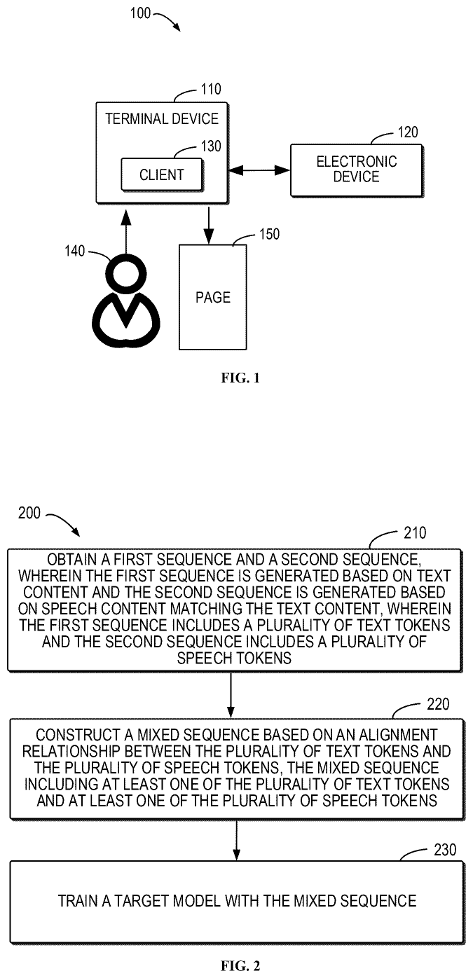

FIG. 1 illustrates a schematic diagram of an example environment 100 in which embodiments of the present disclosure may be implemented. As shown in FIG. 1, the example environment 100 may include a terminal device 110 and an electronic device 120.

In the example environment 100, a client 130 for interacting with the electronic device 120 is installed in the terminal device 110. A user 140 may interact with the client 130 via the terminal device 110 and/or its attached device. The client 130 may be a social application, a content sharing application, or any other suitable application.

In the environment 100 of FIG. 1, if the client 130 is in an active state, the client 130 may provide services such as creation or playback of media content for the user 140.

In addition, the terminal device 110 may present an interface 150 of the client 130. According to the specific service provided, the interaction behavior/preset operation of the user and the like, the content presented by the interface 150 may also change.

In some embodiments, the terminal device 110 communicates with the electronic device 120 to realize the provision of services of the client 130. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for the user (such as a “wearable” circuit, etc.).

The electronic device 120 may be a standalone physical server, a server cluster or distributed system composed of multiple physical servers, or may be a cloud server providing basic cloud computing services such as cloud services, cloud databases, cloud computing, cloud functions, cloud storage, network services, cloud communications, middleware services, domain name services, security services, content distribution networks, as well as big data and artificial intelligence platforms. The electronic device 120 may include, for example, a computing system/server, such as a mainframe, an edge computing node, a computing device in a cloud environment, and the like. The electronic device 120 may provide a background service for the client 130, in the terminal device 110, that supports content presentation.

A communication connection may be established between the electronic device 120 and the terminal device 110. The communication connection may be established in a wired manner or a wireless manner. The communication connection may include, but are not limited to, Bluetooth connections, mobile network connections, universal serial bus connections, wireless fidelity connections, and the like, and the embodiments in the present disclosure are not limited in this regard. In the embodiments in the present disclosure, the electronic device 120 and the terminal device 110 may implement signaling interaction through the communication connection between the electronic device 120 and the terminal device 110.

It should be understood that the structures and functions of the various elements in the environment 100 are described for example purposes only and do not imply any limitation to the scope of the present disclosure.

### Example Processes

FIG. 2 illustrates a schematic diagram of a process 200 of a method for joint training according to some embodiments of the present disclosure, FIG. 3 illustrates a schematic diagram of a first sequence and a second sequence according to some embodiments of the present disclosure. With reference to FIGS. 1 to 3, at block 210, the electronic device 120 obtains a first sequence 310 and a second sequence 320, where the first sequence 310 is generated based on text content and the second sequence 320 is generated based on speech content matching the text content, where the first sequence 310 includes a plurality of text tokens and the second sequence 320 includes a plurality of speech tokens. For example, the plurality of text tokens may be a text token 311, a text token 312, a text token 313, a text token 314, a text token 315, and a text token 316 in FIG. 3. The plurality of speech tokens may be a speech token 321, a speech token 322, a speech token 323, a speech token 324, a speech token 325, and a speech token 326 in FIG. 3.

In some embodiments, the electronic device 120 obtains candidate text content and candidate speech content, and the electronic device 120 determines the candidate text content as the text content in response to the candidate text content and the candidate speech content having consistent expressions, and determines the candidate speech content as the speech content matching the text content. For example, it is assumed that the text expression of the candidate text content is “Today the weather is nice”, and if the speech expression of the candidate speech content is also “Today the weather is nice”, the candidate text content may be determined as the text content, and the candidate speech content may be determined as the speech content matching the text content.

In some embodiments, the electronic device 120 may perform a first preprocessing on the text content to segment the text content into a plurality of minimum units, where the minimum unit may be a word, a phrase, a punctuation mark, a sub-word, or a character. The electronic device 120 may then perform tokenization processing on the obtained minimum unit, thereby obtaining a first sequence 310 containing a plurality of text tokens.

In some embodiments, the electronic device 120 may perform a second preprocessing on the speech content to extract an audio feature. The electronic device 120 may then perform tokenization on the audio feature to obtain a second sequence 320 containing a plurality of speech tokens.

In some embodiments, when performing tokenization on the audio feature, the electronic device 120 may down-sample the audio feature to a certain hertz (hz) to obtain a two-dimensional feature matrix having a time dimension (T) and a feature dimension (D). Then, the electronic device 120 may discretize the two-dimensional feature matrix into T speech tokens with a clustering algorithm, to obtain the second sequence 320.

At block 220, the electronic device 120 constructs a mixed sequence based on an alignment relationship between the text token and the speech token, the mixed sequence including at least one of the plurality of text tokens and at least one of the plurality of speech tokens.

In some embodiments, the electronic device 120 may determine the alignment relationship between the plurality of text tokens and the plurality of speech tokens based on a time period in which each word in the text content appears in the speech content. The alignment relationship may indicate time information of the respective text token in the second sequence 320.

In some embodiments, the electronic device 120 determines ordering information according to the ordering of the at least one of the plurality of text tokens in the text content, and the electronic device 120 determines start time information according to the start time of the at least one of the plurality of speech tokens in the speech content. Then, the electronic device 120 determines the alignment relationship between the plurality of text tokens and the plurality of speech tokens according to the ordering information and the start time information.

In some embodiments, the text token (for example, the first text token 311 in FIG. 3) may be obtained by performing tokenization on one word (for example, the first word “Today”) in the text content, and a ordering 341 of the text token 311 in the text content, that is, the ordering of the word “Today” in the text content. The speech token (for example, the first speech token 321 in FIG. 3) may be obtained by performing tokenization on the audio feature in one segment (for example, the first segment) in the speech content. The speech token may be configured with a timestamp, the timestamp is configured to indicate the start time of the speech token in the speech content, and a start time t1 of the speech token 321 in the speech content is also a start time of the first segment in the speech content. The electronic device 120 may determine that the “Today” word which is ordered as 341 in the text content, appears in the first segment with the start time of t1 in the speech content, and then may determine that the text token 311 and the speech token 321 are a pair of tokens aligned with each other. In this manner, the electronic device 120 may determine the alignment relationship between the plurality of text tokens and the plurality of speech tokens.

Referring to FIG. 3, the first sequence 310 generated based on the text content may include six text tokens, for example, the first sequence 310 includes the text token 311, the text token 312, the text token 313, the text token 314, the text token 315, and the text token 316. The ordering of the text token 311 in the text content is 341, the ordering of the text token 312 in the text content is 342, the ordering of the text token 313 in the text content is 343, the ordering of the text token 314 in the text content is s4, the ordering of the text token 315 in the text content is s5, and the ordering of the text token 316 in the text content is s6.

The second sequence 320 generated based on the speech content may include six speech tokens, for example, the second sequence 320 includes the speech token 321, the speech token 322, the speech token 323, the speech token 324, the speech token 325, and the speech token 326. The start time of the speech token 321 is t1, the start time of the speech token 322 is t2, the start time of the speech token 323 is t3, the start time of the speech token 324 is t4, the start time of the speech token 325 is t5, and the start time of the speech token 326 is t6.

By the method described above, the electronic device 120 may determine that the text token 311 and the speech token 321 are aligned with each other, the text token 312 and the speech token 322 are aligned with each other, the text token 313 and the speech token 323 are aligned with each other, the text token 314 and the speech token 324 are aligned with each other, the text token 315 and the speech token 325 are aligned with each other, and the text token 316 and the speech token 326 are aligned with each other. Thus, the electronic device 120 may accurately obtain the alignment relationship between the plurality of text tokens and the plurality of speech tokens.

In some embodiments, the electronic device 120 may generate the mixed sequence 330 by one of the following ways. As an example, the electronic device 120 may replace, with a first set of text tokens in the plurality of text tokens, a first set of speech tokens in the plurality of speech tokens having the alignment relationship with the first set of text tokens. In some embodiments, the first set of text tokens may refer to one or more of the plurality of text tokens. The electronic device 120 may replace, with the first set of text tokens, the one or more speech tokens in the second sequence 320 in any suitable manner.

As another example, the electronic device 120 may replace, with a second set of speech tokens of the plurality of speech tokens, a second set of text tokens of the plurality of text tokens having the alignment relationship with the second set of speech tokens. In some embodiments, the second set of speech tokens may refer to one or more of the plurality of speech tokens. The electronic device 120 may replace, with the second set of speech tokens, the one or more text tokens in the first sequence 310 in any suitable manner. By means of the method described above, the mixed sequence 330 may be expanded in multiple times within a short time, thereby improving the training efficiency of the model.

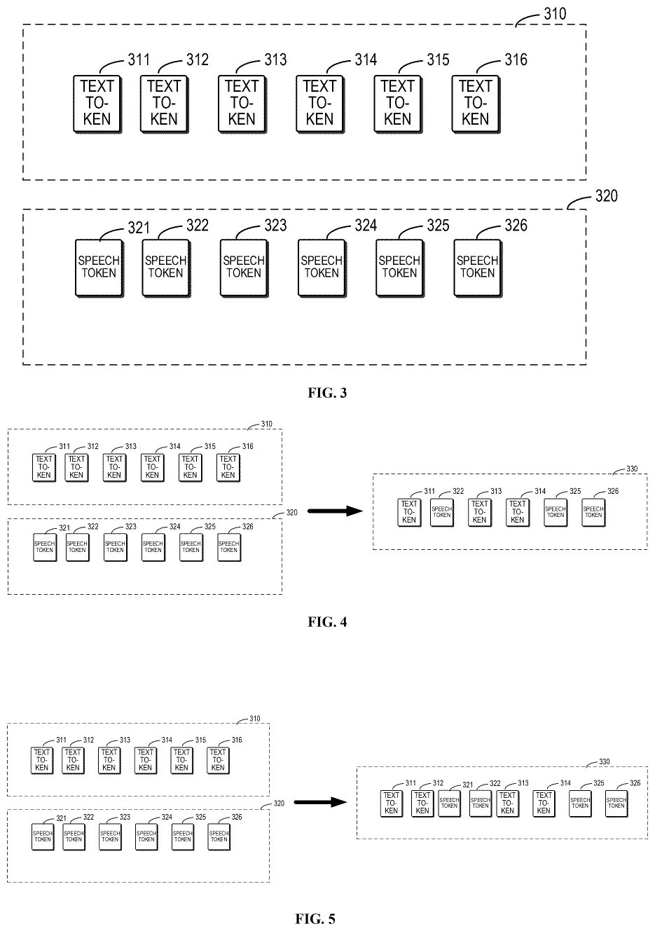

For example, referring to FIG. 4, the electronic device 120 may replace the text token 312, the text token 315, and the text token 316 in the first sequence 310, with the second set of speech tokens (for example, the speech token 322, the speech token 325, and the speech token 326), so as to obtain the mixed sequence 330 including the text token 311, the speech token 322, the text token 313, the text token 314, the speech token 325, and the speech token 326.

In some embodiments, the electronic device 120 may obtain a plurality of different mixed sequences by randomly performing the replacement of each token. In some embodiments, the mixed sequence constructed through the manner of token replacement may also be referred to as a cross-modal continuation sequence, to train the target model to perform the cross-modal continuation task.

In some embodiments, the electronic device 120 may also construct the mixed sequence by the manner of token insertion. For example, the electronic device 120 may insert a third set of text tokens in the first sequence 310, into the second sequence 320. Alternatively, the electronic device 120 may further insert a third set of speech tokens in the second sequence 320, into the first sequence 310.

In some embodiments, an insertion locations of the third group of text tokens or the third group of speech tokens are determined based on the alignment relationship. For example, the electronic device 120 may insert the speech token 321 and the speech token 322 shown in FIG. 4 into the position after the text token 312 in the first sequence 310, thereby forming a new mixed sequence.

In some embodiments, the mixed sequence constructed based on token insertion may also be referred to as a cross-modal transcription sequence, for training the target model to perform a cross-modal transcription task.

In some embodiments, the electronic device 120 may also perform a combination of token replacement and token insertion. As shown in FIG. 5B, the electronic device 120 may insert the speech tokens 321 and 322 into a position following the aligned text tokens 311 and 312, and may replace the corresponding text tokens 315 and 316 with the speech tokens 325 and 326, thereby obtaining the mixed sequence 330 as shown in FIG. 5.

A mixed sequence constructed based on such a manner may perform comprehensive training such as cross-modal transcription task and cross-modal continuation task.

In some embodiments, the electronic device 120 may further determine structural information of the text content, where the structural information indicate a plurality of clauses included in the text content. For example, the electronic device 120 may determine a candidate segmentation point based on a pause time in the alignment information, and construct the plurality of clauses correspondingly.

In some embodiments, the electronic device 120 may determine a mixing strategy based on the structural information, the mixing strategy indicating a type of a token of a respective clause to be retained in the mixed sequence to be constructed.

Further, the electronic device 120 may construct the mixed sequence based on the mixing strategy. Specifically, the electronic device 120 may randomly perform operations introduced above such as token insertion, token replacement for each clause.

Thus, the electronic device 120 may construct a large number of mixed sequences for training the target model to perform the corresponding task.

At block 230, the electronic device 120 trains the target model with the mixed sequence 330.

In some embodiments, such a target model may include, for example, a language model, which may, for example, predict a next token based on existing tokens in the sequence. Depending on construction manner of the mixed sequence, the electronic device 120 may construct the corresponding task with the mixed sequence to train the target model.

For example, in a case where the mixed sequence is constructed by token replacement, the electronic device 120 may construct a corresponding cross-modal continuation task to train the target model. As another example, in a case where the mixed sequence is constructed by token insertion, the electronic device 120 may construct a corresponding cross-modal transcription task to train the target model.

In some embodiments, the target model may also be trained with the first sequence 310 or second sequence 320 separately to perform tasks such as text sequences, speech sequences, and the like.

Therefore, the embodiments in the present disclosure may provide a method for constructing a unimodal sequence and the cross-modal continuation/transcription sequence according to unsupervised data and parallel data of the text and the speech, so that the model simultaneously is capable of performing text continuation, speech continuation, speech-text alignment, speech understanding, and speech generation.

### Example Apparatus and Apparatus

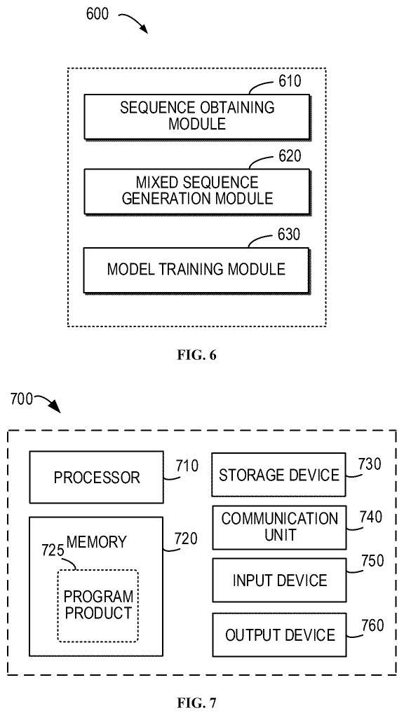

Embodiments of the present disclosure also provide a corresponding apparatus for implementing the above method or process. FIG. 6 is a schematic structural block diagram of a joint training apparatus 600 according to some embodiments of the present disclosure. The apparatus 600 may be implemented or included in the electronic device 120. The various modules/components in the apparatus 600 may be implemented by hardware, software, firmware, or any combination thereof.

As shown in FIG. 6, the apparatus 600 includes a sequence obtaining module 610, configured to obtain a first sequence 310 and a second sequence 320, in which the first sequence 310 is generated based on text content and the second sequence 320 is generated based on speech content matching the text content, in which the first sequence 310 including a plurality of text tokens and the second sequence 320 including a plurality of speech tokens; a mixed sequence generation module 620, configured to construct a mixed sequence 330 based on an alignment relationship between the text tokens and the speech tokens, the mixed sequence including at least one of the plurality of text tokens and at least one speech token of the plurality of speech tokens; and a model training module 630, configured to train a target model with the mixed sequence 330.

In some embodiments, the mixed sequence generation module 620 is further configured to: replace, with a first set of text tokens in the first sequence, a first set of speech tokens in the second sequence that aligns with the first set of text tokens; or replace, with a second set of speech tokens in the second sequence, a second set of text tokens in the first sequence that aligns with the second set of speech tokens.

In some embodiments, the model training module 630 is further configured to construct a cross-modal continuation task based on the mixed sequence to train the target model.

In some embodiments, the mixed sequence generation module 620 is further configured to: insert a third set of text tokens in the plurality of text tokens into the second sequence; or insert a third set of speech tokens in the plurality of speech tokens into the first sequence.

In some embodiments, an insertion position of the third set of text tokens or the third set of speech tokens is determined based on the alignment relationship.

In some embodiments, the model training module 630 is further configured to construct a cross-modal transcription task based on the mixed sequence to train the target model.

In some embodiments, the alignment relationship indicates time information of a respective text token in the second sequence.

In some embodiments, the mixed sequence generation module 620 is further configured to: determine structural information of the text content, the structural information indicating a plurality of clauses included in the text content; determine a mixing strategy based on the structural information, the mixing strategy indicating a type of a token of a respective clause to be retained in a mixed sequence to be constructed; and construct the mixed sequence based on the mixing strategy.

The modules and/or units included in the apparatus 600 may be implemented in various ways, including software, hardware, firmware, or any combination thereof. In some embodiments, one or more modules and/or units may be implemented using software and/or firmware, for example machine-executable instructions stored on a storage medium. In addition to or as an alternative to the machine-executable instructions, some or all of the modules and/or units in the apparatus 600 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 7 illustrates a block diagram of an electronic device 700 in which one or more embodiments of the present disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement the terminal device and/or the electronic device 120 in FIG. 1.

As shown in FIG. 7, the electronic device 700 is in the form of a general-purpose computing device. Components of the electronic device 700 may include, but are not limited to, one or more processors or processors 710, a memory 720, a storage device 730, one or more communication units 740, one or more input devices 770, and one or more output devices 770. The processor 710 may be an actual or virtual processor capable of performing various processes according to a program stored in the memory 720. In a multiprocessor system, a plurality of processors execute computer-executable instructions in parallel to improve the parallel processing capabilities of electronic device 700.

The electronic device 700 typically includes a variety of computer storage media. Such media may be any available media that are accessible to the electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium that can be used to store information and/or data (for example, the training data for training) and that can be accessed within the electronic device 700.

The electronic device 700 may further include an additional removable/non-removable, volatile/non-volatile storage medium. Although not shown in FIG. 7, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 720 may include a computer program product 727 having one or more program modules configured to execute various methods or actions of the various embodiments in the present disclosure.

The communication unit 740 is configured to communicate with other electronic devices through a communication medium. Additionally, the functionality of components of the electronic device 700 may be implemented by a single computing cluster or multiple computing machines capable of communicating through a communication connection. Thus, the electronic device 700 may operate in a networked environment using a logical connection with one or more other servers, network personal computers (PCs), or another network node.

The input device 770 may be one or more input devices such as a mouse, a keyboard, a trackball, or the like. The output device 770 may be one or more output devices, such as a display, a speaker, a printer, or the like. The electronic device 700 may also communicate with one or more external devices (not shown) through the communication unit 740 as needed. The external device, such as a storage device, a display device, etc., communicates with one or more devices that enable users to interact with the electronic device 700, or communicates with any device (e.g., a network card, a modem, etc.) that enables the electronic device 700 to communicate with one or more other electronic devices. Such communication may be performed via an input/output (I/O) interface (not shown).

According to example embodiments in the present disclosure, a computer-readable storage medium having computer-executable instructions stored thereon is provided. The computer-executable instructions are executed by a processor to implement the method described above. According to example embodiments in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general-purpose computer, special computer, or other programmable data processing apparatus to produce a machine that generates an apparatus to implement the functions/acts specified in one or more blocks in the flowchart and/or the block diagram when these instructions are executed through the processors of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is example, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the embodiments disclosed herein.

What is claimed is:

1. A method for joint training, comprising:
obtaining a first sequence and a second sequence, wherein the first sequence is generated based on text content and the second sequence is generated based on speech content matching the text content, wherein the first sequence comprises a plurality of text tokens and the second sequence comprises a plurality of speech tokens;
constructing a mixed sequence based on an alignment relationship between the plurality of text tokens and the plurality of speech tokens, the mixed sequence comprising at least one of the plurality of text tokens and at least one of the plurality of speech tokens; and
training a target model with the mixed sequence.

2. The method of claim 1, wherein constructing the mixed sequence based on the alignment relationship between the plurality of text tokens and the plurality of speech tokens comprises:
replacing, with a first set of text tokens in the first sequence, a first set of speech tokens in the second sequence that aligns with the first set of text tokens; or
replacing, with a second set of speech tokens in the second sequence, a second set of text tokens in the first sequence that aligns with the second set of speech tokens.

3. The method of claim 2, wherein training the target model with the mixed sequence comprises:
constructing a cross-modal continuation task based on the mixed sequence to train the target model.

4. The method of claim 1, wherein constructing the mixed sequence based on the alignment relationship between the plurality of text tokens and the plurality of speech tokens comprises:
inserting a third set of text tokens in the plurality of text tokens into the second sequence; or
inserting a third set of speech tokens in the plurality of speech tokens into the first sequence.

5. The method of claim 4, wherein an insertion position of the third set of text tokens or the third set of speech tokens is determined based on the alignment relationship.

6. The method of claim 4, wherein training the target model with the mixed sequence comprises:
constructing a cross-modal transcription task based on the mixed sequence to train the target model.

7. The method of claim 1, wherein the alignment relationship indicates time information of a respective text token in the second sequence.

8. The method of claim 1, wherein constructing the mixed sequence based on the alignment relationship between the plurality of text tokens and the plurality of speech tokens comprises:
determining structural information of the text content, the structural information indicating a plurality of clauses comprised in the text content;
determining a mixing strategy based on the structural information, the mixing strategy indicating a type of a token of a respective clause to be retained in a mixed sequence to be constructed; and
constructing the mixed sequence based on the mixing strategy.

9. An electronic device, comprising:
at least one processor; and
at least one memory coupled to the at least one processor and storing instructions for execution by the at least one processor, the instructions, when executed by the at least one processor, causing the electronic device to perform operations comprising:
obtaining a first sequence and a second sequence, wherein the first sequence is generated based on text content and the second sequence is generated based on speech content matching the text content, wherein the first sequence comprises a plurality of text tokens and the second sequence comprises a plurality of speech tokens;
constructing a mixed sequence based on an alignment relationship between the plurality of text tokens and the plurality of speech tokens, the mixed sequence comprising at least one of the plurality of text tokens and at least one of the plurality of speech tokens; and
training a target model with the mixed sequence.

10. The electronic device of claim 9, wherein constructing the mixed sequence based on the alignment relationship between the plurality of text tokens and the plurality of speech tokens comprises:
replacing, with a first set of text tokens in the first sequence, a first set of speech tokens in the second sequence that aligns with the first set of text tokens; or
replacing, with a second set of speech tokens in the second sequence, a second set of text tokens in the first sequence that aligns with the second set of speech tokens.

11. The electronic device of claim 10, wherein training the target model with the mixed sequence comprises:
constructing a cross-modal continuation task based on the mixed sequence to train the target model.

12. The electronic device of claim 9, wherein constructing the mixed sequence based on the alignment relationship between the plurality of text tokens and the plurality of speech tokens comprises:
inserting a third set of text tokens in the plurality of text tokens into the second sequence; or
inserting a third set of speech tokens in the plurality of speech tokens into the first sequence.

13. The electronic device of claim 12, wherein an insertion position of the third set of text tokens or the third set of speech tokens is determined based on the alignment relationship.

14. The electronic device of claim 12, wherein training the target model with the mixed sequence comprises:
constructing a cross-modal transcription task based on the mixed sequence to train the target model.

15. The electronic device of claim 9, wherein the alignment relationship indicates time information of a respective text token in the second sequence.

16. The electronic device of claim 9, wherein constructing the mixed sequence based on the alignment relationship between the plurality of text tokens and the plurality of speech tokens comprises:
determining structural information of the text content, the structural information indicating a plurality of clauses comprised in the text content;
determining a mixing strategy based on the structural information, the mixing strategy indicating a type of a token of a respective clause to be retained in a mixed sequence to be constructed; and
constructing the mixed sequence based on the mixing strategy.

17. A non-transitory computer-readable storage medium storing a computer program thereon, the computer program, when executed by a processor, performs operations comprising:
obtaining a first sequence and a second sequence, wherein the first sequence is generated based on text content and the second sequence is generated based on speech content matching the text content, wherein the first sequence comprises a plurality of text tokens and the second sequence comprises a plurality of speech tokens;
constructing a mixed sequence based on an alignment relationship between the plurality of text tokens and the plurality of speech tokens, the mixed sequence comprising at least one of the plurality of text tokens and at least one of the plurality of speech tokens; and
training a target model with the mixed sequence.

18. The non-transitory computer-readable storage medium of claim 17, wherein constructing the mixed sequence based on the alignment relationship between the plurality of text tokens and the plurality of speech tokens comprises:
replacing, with a first set of text tokens in the first sequence, a first set of speech tokens in the second sequence that aligns with the first set of text tokens; or
replacing, with a second set of speech tokens in the second sequence, a second set of text tokens in the first sequence that aligns with the second set of speech tokens.

19. The non-transitory computer-readable storage medium of claim 18, wherein training the target model with the mixed sequence comprises:
constructing a cross-modal continuation task based on the mixed sequence to train the target model.

20. The non-transitory computer-readable storage medium of claim 17, wherein constructing the mixed sequence based on the alignment relationship between the plurality of text tokens and the plurality of speech tokens comprises:
inserting a third set of text tokens in the plurality of text tokens into the second sequence; or
inserting a third set of speech tokens in the plurality of speech tokens into the first sequence.
